(19) United States
(12) Patent Application Publication
(10) Pub. No.: US 2024/0300132 A1
(43) Pub. Date: Sep. 12, 2024

(54) CUTTING DEVICE FOR ELONGATED WORKPIECES

(71) Applicant: Kinemation AG, Flaach (CH)

(72) Inventors: Tolga SERINGEN, Niederhasli (CH); Marco KUMMER, Weiningen (CH)

(21) Appl. No.: 18/268,277

(22) PCT Filed: Dec. 21, 2021
(86) PCT No.: PCT/EP2021/087038

§ 371 Date: Jun. 19, 2023

(30) Foreign Application Priority Data
Dec. 22, 2020 (CH) 01660/20

(51) Int. Cl. B26D 5/20; B26D 3/16; B26D 7/01; B26D 7/06; B26D 7/18

(52) U.S. Cl. CPC B26D 5/20; B26D 3/16; B26D 7/018; B26D 7/0683; B26D 7/1863; B26D 2007/013

(57) ABSTRACT

A cutting device for cutting-off pieces from an elongated workpieces, in particular a tube, having a proximal side, a distal side and a longitudinal axis extending between the proximal and distal side. The cutting device includes a cutting unit having a blade coupled with a blade drive. The blade is reversibly movable via the blade drive between retracted and advanced blade positions. The cutting device includes a proximal support structure arranged with respect to the longitudinal axis proximal of the blade and is configured to guide a distal part of the workpiece to be movable in parallel to and aligned with the longitudinal axis. The cutting device includes a feeder unit including a suction gripper configured for suction-coupling with the elongated workpiece. The feeder unit includes a suction gripper drive, coupled with the suction gripper, configured for moving the suction gripper parallel to the longitudinal axis in a reversible manner.

### FIELD OF THE INVENTION

The present invention relates to the field of cutting elongated workpieces, for example tubes, and in particular to cutting devices for cutting elongate workpieces. The invention may be used for example in the manufacture respectively assembly of products, in particular medical product devices.

### BACKGROUND

A variety of automated or semi-automated manufacture or assembly processes requires the cutting of elongated workpieces to length, that is cutting-off pieces of defined length from elongated workpieces, such as tubes.

In many of such applications a high reliability is required and the cut-off pieces must meet the required length with small tolerances and good reproducibility.

A particular demanding field in this regard is the assembly respectively manufacture of medical product devices, for example in a clean room environment. In addition to general requirements as mentioned before, sterility and the avoidance of contamination, for example by particles, is crucial in many of such applications.

### SUMMARY OF THE INVENTION

In cutting devices, for example tube cutting devices according to the state of the art, the elongated workpiece is typically transported respectively fed to a cutting blade via friction based transport elements, such as driven pulleys and/or transport belts. For this kind of transport, however, relative movement respectively slippage between the elongated workpiece and the transport members is an issue of concern. Further, the transport elements underlie wear which reduces the precision and may further cause contamination of the elongated workpiece or further elements by particles.

It is an overall objective to improve the state of the art regarding the cutting of elongated workpieces, such as tubes, in particular in the before-mentioned context of the assembly or manufacture of medical product devices. Favorably, one or more of the before-mentioned problems is reduced or eliminated.

In an aspect, the overall objective is achieved by providing a cutting device for cutting-off pieces from an elongated workpiece. In particular applications, the elongated workpiece is a tube. The cutting device has a proximal side, a distal side and a longitudinal axis extending between the proximal side and the distal side.

The cutting device includes a cutting unit, the cutting unit including a blade and a blade drive, wherein the blade is coupled with the blade drive. The blade is reversible movable via the blade drive between a retracted blade position and an advanced blade position. The blade defines a cutting plane that generally extends transverse to the longitudinal axis. In designs where the cutting device comprises a number of processing channels respectively is designed for processing a number of elongated workpieces in parallel as explained further below, more or all blades may be realized in an integral manner and may in particular include a common cutting edge. The cutting device generally has a proximal part and a distal part. A part of the cutting device that is located proximal of the blade, in particular the proximal support structure and an optional centering structure as explained further below, forms the proximal part of the cutting device. A part of the cutting device that is located distal of the blade, in particular an optional distal support structure, forms the distal part. The uncut elongated workpiece or at least a portion thereof is generally received and/or seated in the proximal part of the cutting device, while cut-off-pieces that have been cut-off from the elongated workpiece may be received and/or seated in the distal part of the cutting device. In the area of the proximal support structure as well as an optional centering structure, the elongated workpiece generally extends along a straight line. The cutting device is generally configured to receive the elongated workpiece proximally from the blade respectively in its proximal part, for example at the proximal side of the cutting device. Further, the cutting device is configured to release pieces that are cut-off from the elongated workpiece distal from the blade respectively in its distal part, for example at the distal side of the cutting device.

The cutting device further includes a proximal support structure. The proximal support structure is arranged proximal of the blade in direction of the longitudinal axis and is configured to support and guide a distal part of the elongated workpiece to be movable parallel to and aligned with the longitudinal axis. Further, the proximal support structure favorably supports the elongated workpiece respectively its distal part in vertical direction with respect to gravity.

The cutting device further includes a feeder unit. The feeder unit includes a suction gripper. The suction gripper is configured for suction-coupling with an elongated workpiece. The feeder unit further includes a suction gripper drive, wherein the suction gripper drive is coupled with the suction gripper. The suction gripper drive is configured for moving the suction gripper parallel to the longitudinal axis in a reversible manner.

In a further aspect, the overall objective is achieved by a method for cutting-off pieces from an elongated workpiece. The method includes repeatedly executing a cutting sequence. The cutting sequence may include the steps of:
a) suction-coupling a distal part of the elongated workpiece with a suction gripper, wherein the suction gripper is in a pickup position;
b) moving the suction gripper with the coupled elongated workpiece from the pickup position parallel to a longitudinal axis in a distal direction into a placing position, wherein, in the placing position, the elongated workpiece projects in distal direction beyond a blade;
c) releasing the suction-coupling of the suction gripper and the elongated workpiece;
d) moving the blade form a retracted blade position into an advanced blade position, thereby cutting-off a piece form the elongated workpiece, and back into the retracted blade position;
e) moving the suction gripper from the placing position into the pickup position.

Typically, the steps of a cutting sequence are executed from step (a) to step (e) in a sequential manner. In some embodiments, however, some steps may be executed in parallel, in an interlaced manner or in a different order. The cutting device may in particular be designed for use in a clean-room environment and/or may be part of an assembly line as explained further below.

In a further aspect, the overall objective is achieved by providing an assembly line for the assembly of a product device, in particular a medical product device. The assembly line includes at least one cutting device according to any embodiment in accordance with the present disclosure.

In a further aspect, the overall objective is achieved by the use of a cutting device according to any embodiment in accordance with the present disclosure, and/or of an assembly line according to any embodiment in accordance with the present disclosure, and/or of a method according to any embodiment in accordance with the present disclosure in the assembly of a product device, in particular a medical product device.

Embodiments of a method for cutting an elongated workpiece may in particular be carried out using an embodiment of a cutting device in accordance with the present disclosure. The cutting device may accordingly be configured to carry out the method. Consequently, disclosed embodiments of the cutting device also disclose corresponding embodiments of the cutting method and vice versa.

The expression “elongated workpiece” refers to a workpiece that may generally extend along an, for example, straight workpiece axis, and have an extension along the workpiece axis that is large compared to the dimensions transverse to the workpiece axis. Typical examples of such elongated workpieces are wires, strings, bands and in particular tubes. Typically, the elongated workpiece is symmetrical with respect to its workpiece axis, for example rotational symmetrical. The expression “cutting-off” generally refers to cutting to length pieces of an elongated workpiece transverse, in particular perpendicular, to its longitudinal axis. The elongated workpiece generally has a cross section that is substantially constant along the workpiece axis. Generally, the expression “elongated workpiece” further refers to the workpiece before cutting (proximal of the blade), while cut-off pieces are referred to as such. The elongated workpiece may be bendable respectively flexible and may optionally also assume a non-straight configuration, for example when provided on a spool or reel.

The present disclosure generally focusses on tubes respectively tubular workpieces as typical example, without excluding other types of elongated workpieces. Such tubes may in particular be used in the manufacture respectively assembly of medical product devices, for example balloon catheters. In typical applications, the tubes may have an outer diameter in the range of 1 mm to 5 mm or up to 10 mm. Generally, an upper limit for the diameter is given by the fact that the blade must cut the elongated workpiece, for example a tube, in a single cutting movement in order to achieve the accuracy that is typically required, and further by the weight that limits the coupling and lifting via suction.

In a specific example, the tube is made from Polyamide and may have an outer diameter of 1.95 mm and an inner diameter of 1.75 mm. The length of the pieces that are cut off may for example be 75 mm with a tolerance of +/−3 mm. In another specific example, the tube is a heat shrinkable tube which is made from Polyolefin and may have an outer diameter of 2.54 mm and an inner diameter of 2.1 mm. The length of the pieces that are cut off may in this example be 10 mm with a tolerance of +/−0.5 mm. It is to be understood that the dimensions are merely exemplary and are further nominal dimensions. In the overall context of a medical product device, the elongated workpiece, in particular a tube, may be part of the product device as such or may be used temporarily for auxiliary purposes. Further typical materials for the elongated workpiece, in particular tubes, are, for example, PEEK, PTFE, PU, PE, PUR, or EPDM.

The pieces that are cut-off from the elongated workpiece are cut-off at its distal side, respectively a distal end portion of the elongated workpiece is cut-off with each cutting sequence. In the following, the elongated workpiece is generally assumed as extending in a straight respectively “linear” manner. This is particular the case for the distal portion of the elongated workpiece from which the pieces are cut off. An axis of the elongated workpiece respectively its distal portion is also referred to as workpiece axis. The elongated workpiece as a whole, however, may in principle also be curved or bended and be provided, for example on a spool, roll or reel.

In accordance with the present disclosure, the elongated workpiece is not manipulated, in particular moved respectively transported, by way of physical contact and friction based via moving belts, pulleys, rollers, drums, or the like, but is lifted by the suction gripper and is transported by moving the suction gripper with the elongated workpiece being coupled therewith. Thereby, contamination of the elongated workpiece as well as slippage are largely or fully excluded. In this manner, high accuracy and reproducibility are achieved, while meeting the strict requirements that are typical for example in the field of medical product devices regarding sterility and contamination. The cutting device may in particular be used in a clean room environment.

When being processed by the cutting device, the elongated workpiece respectively a distal part thereof generally moves respectively is transported in a direction from proximal towards distal and in alignment with respectively parallel to the longitudinal axis. In dependence of the design, the workpiece may be provided at the proximal side as virtually endless material, for example on a spool or reel, or may be pre-cut and extend in a substantially straight manner. While providing the elongated workpiece on a spool or the like is less costly, it has the drawback of undesired curvature and bending. In applications requiring a high precision, providing the elongated workpiece in a pre-cut and substantially straight manner is therefore favorable.

The cut-off length of a piece that is cut off from the elongated workpiece is given by the distance by which the elongated workpiece projects beyond the blade in the distal direction prior to being cut off in step (d). By adjusting the placing position, the cut-off length may be adjusted as desired.

In operation, the suction gripper generally moves repeatedly respectively cycles between the pickup position and the placing position with each cutting sequence. In particular, for initially picking up a new elongated workpiece that is fed respectively inserted into the cutting device, the suction gripper may be controlled to move to a suction gripper position that is proximal from the pickup position.

The movement via which the blade is moved from the retracted blade position into the advanced blade position is the cutting movement. The blade is generally aligned transverse to the longitudinal axis, thereby ensuring a perpendicular cutting of the elongated workpiece. Different kinds of movement are possible between the retracted blade position and the advanced blade position, for example a pivoting movement. In a particular embodiment, the movement is a linear movement. In such embodiments, the blade drive may be or include a linear drive, for example a spindle drive or a pneumatic cylinder. In a particular embodiment, the blade drive is or includes a linear motor.

The movement of the blade from the retracted blade position into the advanced blade position (cutting movement) and back in into retracted blade position pursuant to step (d) of the method may be carried out directly after each other. Alternatively, however, the blade may in principle be moved from the advanced blade position back into the retracted blade position at a different point of the cutting sequence, in particular in parallel with step (e), subsequent to step (e) respectively prior to step (a), in parallel with step (a), or between step (a) and step (b).

The proximal support structure is typically designed and arranged such that the elongated workpiece is supported with respect to gravity and is guided in a horizontal manner respectively perpendicular to the direction of gravity. Consequently, also the longitudinal axis generally extends horizontally. Further, the proximal support structure is favorably designed to guide the elongated workpiece in a substantially play-free manner That is, the elongated workpiece is movable parallel to and aligned with the longitudinal axis respectively along the workpiece axis, but is restricted/bound transverse to the longitudinal axis.

For coupling with the elongated workpiece, the suction gripper includes a workpiece coupling structure. The workpiece coupling structure is favorably shaped to enable a relative movement between the suction gripper respectively its workpiece coupling structure and the elongated workpiece along, respectively parallel to the longitudinal axis with the suction-coupling being active. Further, the workpiece coupling structure is favorably shaped in a manner that prevents a relative movement of the elongated workpiece with respect to the suction gripper in a direction transverse to the longitudinal axis. The workpiece coupling structure may in particular be designed as a concave, for example notch-shaped structure that continuously extends parallel to the longitudinal axis from a workpiece facing front of the suction gripper and has a contour that is inverse to a part of the outer contour of the elongated workpiece, thereby positive-locking the elongated workpiece transverse to the longitudinal axis. In particular, for an elongated workpiece having a substantially circular cross section, such as a wire or a tube, the workpiece coupling structure may have the shape of a concave cylinder section that extends parallel to the longitudinal axis and a diameter that generally corresponds to the diameter respectively (outer) diameter of the elongated workpiece. The concave cylinder section favorably corresponds to somewhat less than a half cylinder, such that the suction gripper respectively its workpiece coupling structure does not extend to the workpiece axis if the suction gripper is coupled to the elongated workpiece. The part of the concave workpiece coupling structure that is most set back from the workpiece-facing front of the suction gripper is referred to as workpiece coupling structure vertex. The surface of the workpiece coupling structure that contacts the elongated workpiece is also referred to as workpiece contacting surface.

For the suction-coupling, the suction gripper includes at least one fluidic conduit that extends respectively opens into the workpiece-contacting surface of the workpiece coupling structure with an aperture. In an operational configuration, the fluidic conduit is coupled with a vacuum supply respectively negative pressure supply, in particular a vacuum or suction pump via corresponding tubing and favorably a control valve that is controlled by a control unit as discussed further below.

In an embodiment, the blade and the suction gripper are arranged in a vertical direction above the proximal support structure as well as an optional distal support structure as explained further below. Without excluding other types of design, such setup is generally assumed in the following, with directional terms such as upwards, downwards, above, below being used with reference to the vertical direction. For such embodiment, the cutting plane generally extends in vertical direction and in a horizontal direction transverse to the longitudinal axis. The uppermost part of the elongated workpiece respectively a distal part thereof (defined by a line that extends parallel to the workpiece axis and is displaced upward with respect to the workpiece axis by half of the workpiece diameter for a workpiece of circular cross section) is referred to as upper workpiece vertex, while the lowermost part of the elongated workpiece respectively a distal part thereof (defined by a line that extends parallel to the workpiece axis and is displaced downwards with respect to the workpiece axis by half of the workpiece diameter for a workpiece of circular cross section) is referred to as lower workpiece vertex.

The suction via which the workpieces may be coupled to the suction gripper as discussed before acts generally in a vertical direction respectively against the direction of gravity. Establishing the coupling may result in a lifting of the workpieces by, for example 1 mm.

In an embodiment, the suction gripper includes a proximal suction gripper element and a distal suction gripper element, wherein the proximal suction gripper element and the distal suction gripper element are arranged spaced apart along the longitudinal axis. The proximal suction gripper element and the distal suction gripper element are each configured for suction-coupling with the elongated workpiece. In a particular embodiment, the suction coupling of the proximal suction gripper element and the distal suction gripper element with the elongated workpiece is independently activatable and deactivatable.

For an embodiment with a proximal suction gripper element and a distal suction gripper element, the proximal suction gripper element may include a proximal workpiece coupling structure and the distal suction gripper element may include a distal workpiece coupling structure, with the proximal workpiece coupling structure and the distal workpiece coupling structure being generally designed in an identical manner and as discussed before. The proximal suction gripper element and the distal suction gripper element may be spaced apart by, for example, 75 mm. An arrangement with a proximal suction gripper element and a distal suction gripper element ensures a reliable lifting of the elongated workpiece on a sufficient length with good longitudinal guidance.

In order to allow independent activation and deactivation of the suction-coupling, separate control valves may be provided. The favorable properties of independent activation and deactivation are discussed in more detail further below.

In an embodiment, the proximal support structure includes a proximal guide groove. The proximal guide groove is configured to receive a distal part, in particular the distal end part, of the elongated workpiece.

In a cross sectional view, the proximal guide groove may be shaped in principle similar to the workpiece of coupling structure of the suction gripper as discussed before. That is, it is favorably shaped to enable a relative movement between the proximal guide groove the elongated workpiece along respectively parallel to the longitudinal axis, but prevents a relative movement of the elongated workpiece with respect to the proximal support structure in a direction transverse to the longitudinal axis. The proximal guide groove continuously extends parallel to, respectively is aligned with the longitudinal axis and has a contour that is inverse to a part of the outer contour of the elongated workpiece, thereby positive locking the elongated workpiece transverse to the longitudinal axis. In particular, for an elongated workpiece having a substantially circular cross section, the proximal guide groove may have the shape of a concave cylinder section that extends parallel to the longitudinal axis and a diameter that generally corresponds to the diameter of the elongated workpiece. Similar to the workpiece support structure of the suction gripper, the proximal guide groove may correspond to somewhat less than a half cylinder. The ground of the proximal guide groove is also referred to as proximal guide groove vertex. The proximal guide groove may for example be realized by machining, for example milling and/or grinding, in a solid proximal support structure body.

If the suction-coupling of the suction gripper is deactivated, the elongated workpiece respectively its distal part rests in the proximal guide groove with the lower workpiece vertex contacting its ground, in particular the proximal guide groove vertex, while a gap is present between the upper workpiece vertex and the workpiece coupling structure vertex. If the suction-coupling of the suction gripper is activated, the elongated workpiece is lifted and a gap is present between the proximal guide groove vertex and the lower workpiece vertex, while the upper workpiece vertex contacts the workpiece coupling structure vertex of the suction gripper. For embodiments of the suction gripper with spaced-apart proximal suction gripper element and a distal suction gripper element, this holds true for each of the proximal and distal suction gripper element.

In a particular embodiment including a proximal guide groove, the cutting device includes a centering structure in alignment with the proximal guide groove. The centering structure is arranged proximal of the proximal guide groove The final fine centering of the elongated workpiece respectively its distal part with respect to the proximal support structure and accordingly the positioning with respect to the blade is favorably achieved by the interaction of the elongated workpiece with the proximal support structure, in particular a proximal guide groove as discussed before. A dedicated centering structure that is arranged proximal of the proximal guide groove is favorable for pre-centering of the elongated workpiece, thereby ensuring a smooth and substantially aligned transition of the elongated workpiece into the proximal guide groove. The centering structure may include an elongated for example V-shaped or U-shaped centering groove that may be realized machining, in particular milling and/or grinding in a centering structure body. Further, the centering structure may include a centering structure body in form of a sheet material, for example a sheet metal, that is bent to from a V- or U-shaped centering groove. Generally, a centering structure that is made from bent sheet metal is less precise as compared to a machined centering structure as mentioned before, but has the advantage of being less costly. In a particularly favorable embodiment, the centering structure includes a first centering structure and a second centering structure, with the first centering structure and the second centering structure being arranged adjacent to each other and proximal of the proximal guide groove. The first centering structure of such embodiment is arranged proximal of the second centering structure. The first centering structure may include a first centering groove and may, for example, be made from bent sheet material as discussed before, and the second centering structure may include a second centering groove and, for example, be made from machined material as discussed before. The combination of first centering structure and second centering structure results in a two-step centering.

In an embodiment, the proximal support structure is configured for suction-coupling with the elongated workpiece. For this type of embodiment, the elongated workpiece may accordingly be suction-coupled to both the suction gripper and the proximal support structure. Generally, suction forces exerted by the suction gripper and the proximal support structure act on the elongated workpiece from opposite sides. In particular, the suction force that is exerted by the suction gripper may act on the upper side of the elongated workpiece, thereby exerting an upwards directed or lifting force on the elongated workpiece respectively a part, in particular the distal end part, thereof. The suction force that is exerted by the proximal support structure may act on the lower side of the elongated workpiece respectively the distal end part thereof, thereby exerting a downwards directed force or holding-down force. Providing such suction coupling of the proximal support structure with the elongated workpiece is favorable for a defined and straight positioning of the elongated workpiece with respect to the proximal support structure, in particular a proximal guide groove, over its length.

For the suction-coupling, the proximal support structure of such embodiment may include at least one fluidic conduit that extends respectively opens into a workpiece-contacting surface of the support structure, for example a proximal support structure as discussed before with a corresponding aperture or a number of apertures. Further particular embodiments and variants are discussed further below.

In a particular embodiment, the proximal support structure is configured for suction-coupling with the elongated workpiece at a proximal coupling position, a middle coupling position and a distal coupling position, wherein the proximal coupling position, the middle coupling position and the distal coupling position are spaced apart along the longitudinal axis. The suction-coupling of the proximal support structure with the elongated workpiece at the proximal coupling position, the middle coupling position and the distal coupling position is in each case independently activatable and deactivatable.

In such embodiment, the proximal support structure generally includes separate fluidic conduits that extend respectively open into a workpiece-contacting surface of the proximal support structure at the proximal coupling position, the middle coupling position and the distal coupling position. At each of the proximal coupling position, the middle coupling position and the distal coupling position one or more apertures are provided in the workpiece-contacting surface and in fluidic coupling with the respective fluidic channel. In order to allow independent activation and deactivation of the suction-coupling, a corresponding set of independently controllable control valves may be present. In further variants, the proximal support structure is configured for suction-coupling with the elongated workpiece at another number of positions, in particular more than three positions. The distal coupling position is favorably located in close longitudinal proximity of the blade, in particular directly proximal of the blade to ensure proper positioning of the elongated workpiece and prevent any movement thereof during cutting.

In a corresponding method that may be carried out according to this type of embodiment, step (c) of the method as explained before includes:
c1) suction-coupling the proximal support structure with the elongated workpiece at the distal coupling position;
c2) suction-coupling the proximal support structure with the elongated workpiece at the middle coupling position and releasing the suction-coupling of the distal suction gripper element with the elongated workpiece;
c3) suction-coupling the proximal support structure with the elongated workpiece at the proximal coupling position and releasing the suction-coupling of the proximal suction gripper element with the elongated workpiece.

It has been found that this procedure provides a particularly smooth and precise positioning of the elongated workpiece respectively its distal part with respect to the proximal support structure, which is favorable for precise cutting result.

In the placing position where step (c) is executed, a proximal suction gripper part may be positioned proximal of the proximal coupling position, while a distal part may be positioned between the middle coupling position and the distal coupling position.

Activation and deactivation of the suction coupling may in each case be done simultaneously or with a short overlap period, typically, in the range of milliseconds.

In an embodiment, the cutting device includes a distal support structure. The distal support structure is arranged distal of the blade and is configured to receive pieces being cut-off from the elongated workpiece. Similar to the proximal support structure as explained before, the distal support structure is configured to guide pieces that are cut-off from the elongated workpiece to be movable in parallel to and aligned with the longitudinal axis.

The distal support structure may be aligned with the proximal support structure and may generally extend the proximal support structure distal of the blade in distal direction. The distal support structure may be generally designed in an analogue manner to the proximal support structure as explained before. In a particular embodiment, the distal support structure includes a distal guide groove as explained before that may be realized in the same manner as a proximal guide groove. The distal guide groove may be aligned with the proximal guide groove and extend the proximal guide groove in distal direction. The distal guide groove may be realized for example by machining, for example milling and/or grinding, in a solid distal support structure body. In an embodiment, a proximal support structure body and a distal support structure body are realized in an integral manner. Typically, the distal support structure is shorter than the proximal support structure with respect to the longitudinal axis.

In a particular embodiment including a distal support structure, the distal support structure is configured for suction-coupling with cut-off pieces subsequent to being cut off from the elongated workpiece.

By suction-coupling the distal support structure with the cut-off pieces that have been cut-off from the elongated workpiece, it is ensured that the cut-off pieces of the elongated workpieces (which are generally small and light) do not move out of the respectively away from the support structure in an uncontrolled manner. Typically, the suction is continuously switched on respectively activated during operation of the cutting device. The distal support structure may be configured for suction coupling with cut-off pieces at one or more positions along the longitudinal axis. Favorably, the distal coupling structure is in any case configured for suction-coupling with the cut-off pieces in close proximity to the blade.

A distal support structure is particularly favorable in a scenario where the cut-off workpieces are subsequently further handled automatically, for example by transferring them to a subsequent assembly station via a lifting unit as explained further below, since the cut-off pieces are presented in a defined geometrical position and orientation by the distal support structure. In some other situations, for example if the cut-off pieces shall not be further processed automatically, a distal support structure may be omitted and the cut-off pieces may, for example, fall into a bin or tray that is positioned distal from and below the blade.

In an embodiment, the cutting device includes an ionization unit. The ionization unit may include an ionization nozzle that is arranged distal of the blade, for example in the area of a distal support structure as discussed before. Via an ionization flow that is generated by the ionization unit, electrostatic charge that may be present at the cut-off pieces is neutralized respectively electrostatic charging of the cut-off pieces is avoided.

In an embodiment, the cutting device may include a particle removal unit. The particle removal unit may include a negative pressure respectively suction device in fluidic coupling with a particle removal nozzle. The particle removal nozzle may be arranged distal of the blade, for example distal of a distal support structure as discussed before. In a typical design, the particle removal nozzle may form the most distal part of the cutting device.

In an embodiment, the cutting device includes a blade guide. The blade guide may generally be aligned with the blade respectively the cutting plane as explained before and extends transverse to the longitudinal axis. The blade guide may project transverse, in particular perpendicular, from the proximal and optional distal support structure. The blade guide may include a slit into which the blade dives, with the slit corresponding to the cutting plane. During a cutting movement, the blade is guided and supported by the blade guide, thereby ensuring that the blade does not deform respectively bend transverse to the cutting direction, and that the elongated workpieces are cut perpendicular to their respective axes. Favorably a part of the blade, including the cutting edge, dives into respectively is seated in the slit also in the retracted blade position. The blade guide may be arranged between and adjacent to the proximal and distal support structure, for example the proximal and distal guide groove and separate them. In a retracted blade position, a continuous passage exists between the proximal and distal guide support structure respectively the proximal and distal guide groove.

In an embodiment, the cutting device further includes and/or is configured for operatively coupling with a control unit. The control unit is configured for controlling operation of the cutting device, in particular operation of the blade drive, the suction gripper drive and the suction-coupling of the suction gripper with the elongated workpiece. In addition, the control unit may further be configured for monitoring/supervising operations of the cutting device.

The assembly line may include a number of assembly stations which may be arranged as generally known in the art, for example in sequential order along an assembly direction. The assembly station may include one or more cutting devices according to any embodiment in accordance with the present disclosure. The one or more cutting devices form assembly stations. Some or all assembly stations that are arranged subsequent to a cutting unit may be configured for further processing the cut-off pieces, for example by widening, slitting, or hole-cutting.

In an embodiment, the cutting device includes a lifting unit that is arranged to lift cut-off pieces. The lifting unit is arranged distal of the blade and may in particular be arranged distal of a distal support structure, for example between a distal support structure and a particle removal nozzle as explained before. The lifting unit may include a lifting platform and a lifting drive. Via the lifting drive, the lifting platform is movable, in particular in vertical direction, between an aligned position and an offset position. The lifting platform may include a lifting platform guide groove. The lifting platform guide groove may be generally designed in the same manner as a guide groove, in particular a distal guide groove, as explained before and may be arranged in a lifting platform body. In the aligned position, the lifting platform guide groove is aligned with the distal guide groove and extends the distal guide groove in distal direction, while it is vertically offset from the distal guide groove in the offset position.

In operation, already cut-off pieces are pushed by the elongated workpiece in the distal direction in step (b) of the cutting sequence with a most distal cut-off piece being pushed into the lifting platform guide groove. In step (b), the lifting platform is accordingly in the aligned position. Subsequently, the lifting platform may be moved into the offset positon which may in particular be above the aligned positon. In the offset position, the cut-off piece that is seated in the lifting platform guide groove may be picked up, for example via suction, and the lifting platform may subsequently be moved back into the aligned positon.

In an embodiment, the method further includes guiding a distal part of the elongated workpiece by a proximal support structure such that the elongated workpiece is movable in a guided manner parallel to and aligned with the longitudinal axis.

In an embodiment, step (c) of the method includes suction-coupling the proximal support structure with the elongated workpiece, and step (a) includes releasing the suction-coupling of the proximal support structure with the elongated workpiece.

In an embodiment, the method further includes executing an initialization sequence prior to repeatedly executing the cutting sequence as mentioned before. The initialization sequence may include:
i-a) suction-coupling the elongated workpiece with the suction gripper;
i-b) moving the suction gripper with the coupled elongated workpiece parallel to the longitudinal axis in the distal direction while the blade is in the advanced blade position, such that the blade abuts the elongated workpiece and pushes the elongated workpiece into the proximal direction;
i-c) releasing the suction coupling of the suction gripper and the elongated workpiece;
i-d) moving the blade from the advanced blade position into the retracted blade position.

The initialization sequence may be executed subsequent to feeding or inserting a new elongated workpiece into the cutting device. In step (i-b) of the initialization sequence, the distal end respectively front of the elongated workpiece comes into contact respectively abuts the blade. In dependence of the length by which the elongated workpiece projects beyond the suction gripper in distal direction, the elongated workpiece is pushed back in proximal direction, while being suction-coupled to the suction gripper. The blade accordingly serves as stop for the elongated workpiece. In this way, it is ensured that the distal end of the workpiece is in a defined position respectively projects beyond the suction gripper by a defined distance which is defined by blade. For the steps (i-a) and (i-b), the suction gripper pics up the elongated workpiece such that its distal front projects beyond the suction gripper in distal direction by a sufficient distance to ensure that the elongated workpiece comes into contact respectively abuts the blade. The end position of the suction gripper movement in step (i-b) may, for example, be the placing position.

It is noted that it may be necessary to discard the cut-off piece that is cut-off from the elongated workpiece subsequently in the first cutting sequence subsequent to the initialization sequence.

So far, a cutting device and related aspects have been discussed in the context of embodiments where the cutting device is configured for cutting a single elongated workpiece at a time. In some typical embodiments, in particular in the context of an industrial assembly process, however, the cutting device is designed for processing respectively cutting a maximum number of more than one elongated workpieces at the same time respectively in parallel. The maximum number of elongated workpieces that may be processed in parallel is also referred to as number of processing channels. In embodiments with more than one processing channel, a number of proximal and optionally distal support structures is provided, wherein each proximal respectively distal support structure is configured to interact with a respective elongated workpiece in a one-to-one relation. The number of proximal respectively support structures corresponds to the number of processing channels. Each of the proximal respectively distal support structures is typically designed in the same way according to any embodiment as discussed before. Accordingly, all embodiments that are described above may hold true for each of the proximal respectively distal support structures. The proximal respectively distal support structures may be arranged side-by-side and each have a main extension direction parallel to the longitudinal axis as discussed before. The number of proximal respectively distal support structures may be distinct from each other or be realized in a partly or fully integral manner. In particular, a separate proximal respectively distal guide groove may be provided for each processing channel. The proximal respectively distal guide grooves may, however, be arranged in a common proximal respectively common distal support structure body as explained before.

Similarly regarding a centering structure, a fully separate centering structure may be present for each processing channel of the cutting device. The centering structures, may, however, be realized in a partly or fully integral manner, for example via a piece of sheet metal as common centering structure body in which a U-shaped or V-shaped groove is formed as centering groove for each processing channel, and/or a generally solid body as common centering structure body in which a corresponding U-shaped or V-shaped groove is formed as centering groove for each processing channel.

Similarly, the feeder unit may include a number of suction grippers, with each suction gripper being configured for vacuum coupling with a respective elongated workpiece in a one-to-one manner. The number of suction grippers corresponds to the number of processing channels. The single suction grippers may be structurally distinct or may be realized in a partly or fully integral manner or be connected to form an integral structural unit. While the feeder unit may in principle include a number of suction gripper drives that corresponds to the number of suction grippers respectively processing channels, with each suction gripper drive being coupled with a respective suction gripper in a one-to-one manner, only a single suction gripper drive is present in a typical embodiment which is coupled with each of the vacuum suction grippers in parallel to move the vacuum suction grippers in each case simultaneously respectively in parallel.

The cutting unit may include a number of blades that corresponds to the number of processing channels. The single blades may be structurally distinct or may be realized in a partly or fully integral manner, for example by a single blade element that extends transverse to the longitudinal axis and spans all of the elongated workpieces, thereby allowing to cut all of the elongated workpieces. Alternatively, a number of blade elements may be present that each span a number of elongated workpieces. In embodiments with a number of separate blades as discussed before, a number of blade drives may be present that corresponds to the maximum number of elongated workpieces respectively the number of processing channels, with each blade drive being coupled with a respective blade in a one-to-one manner. Typically, however, a single common blades drive is present which is coupled with each of the blades.

In embodiments including a blade guide, a common guide may be present into which the blade element dives. If a separate blade is present, a common or a corresponding number of separate blade drives may be present.

### BRIEF DESCRIPTION OF THE DRAWINGS

FIG. 1 shows an exemplary embodiment of a cutting device in a perspective view;

FIG. 2 shows the cutting device of FIG. 1 in a further perspective view;

FIG. 3 shows a distal part of the cutting device of FIG. 1 in a perspective view;

FIG. 4 shows the distal part of the cutting device of FIG. 1 in a further perspective view;

FIG. 5a schematically shows the coupling of a support structure with an elongated workpiece;

FIG. 5b schematically shows the coupling of a guide suction gripper element with an elongated workpiece;

FIG. 6 schematically shows an assembly line in a functional view;

FIG. 7 shows elements of the cutting device of FIG. 1 in a perspective view;

FIG. 8 shows further elements the cutting device of FIG. 1 in a perspective view;

FIG. 9 shows a section from FIG. 8 in a detailed view.

### DESCRIPTION OF THE EMBODIMENTS

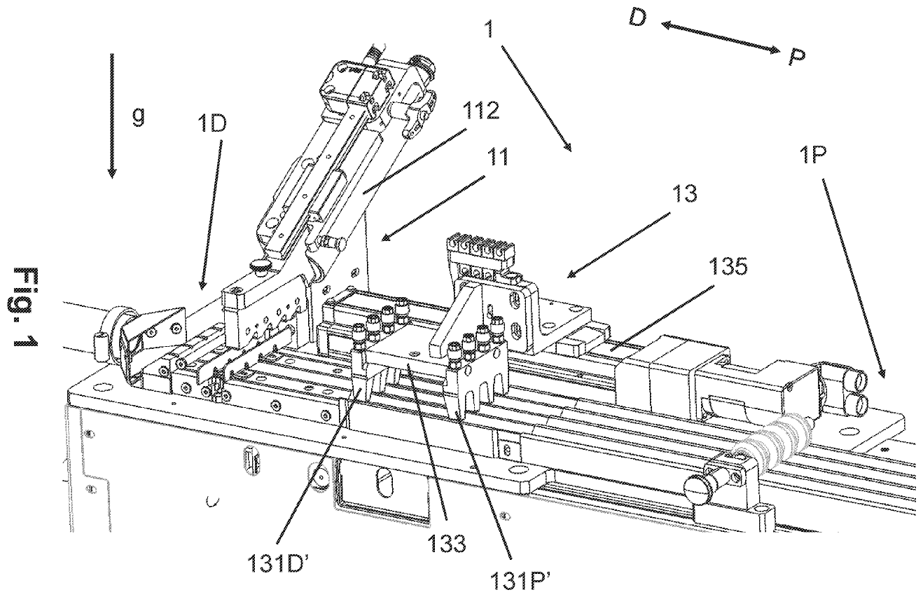

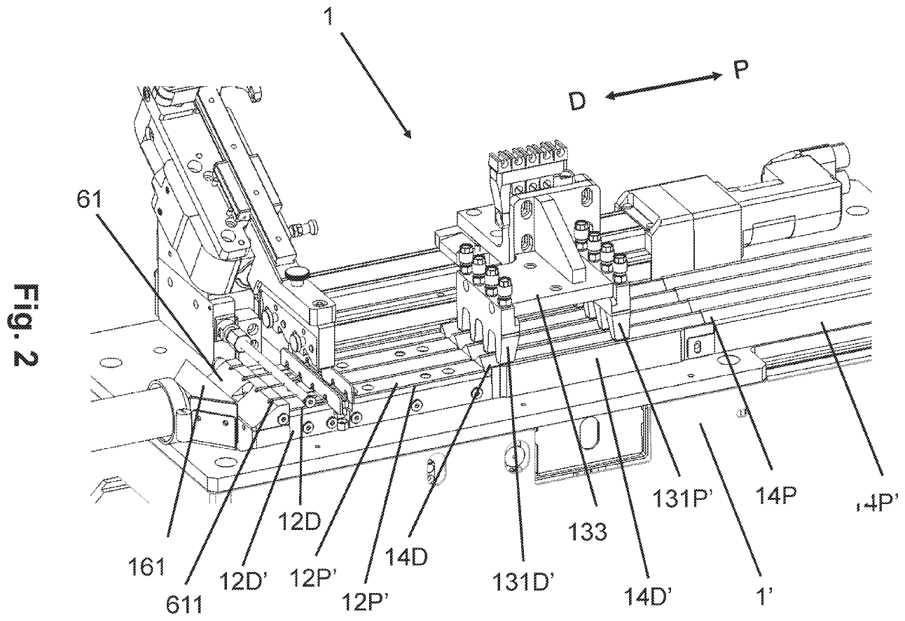

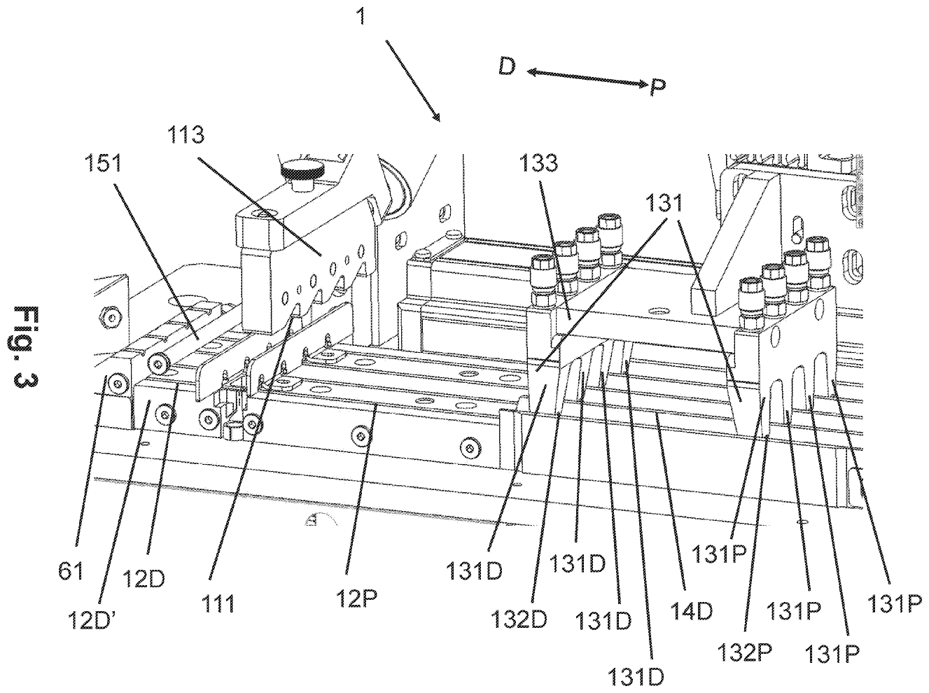

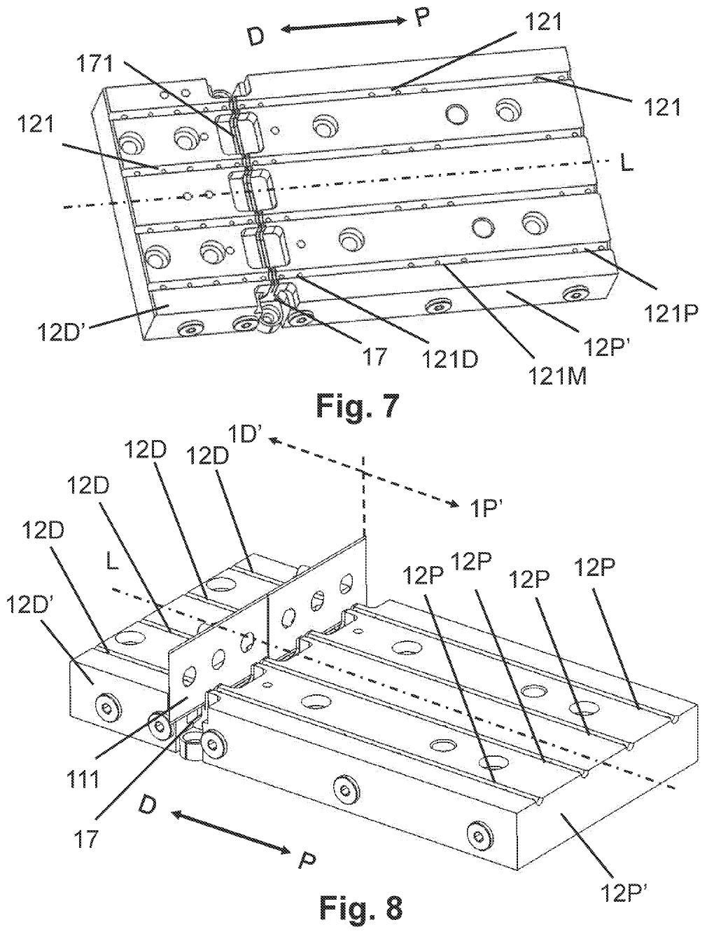

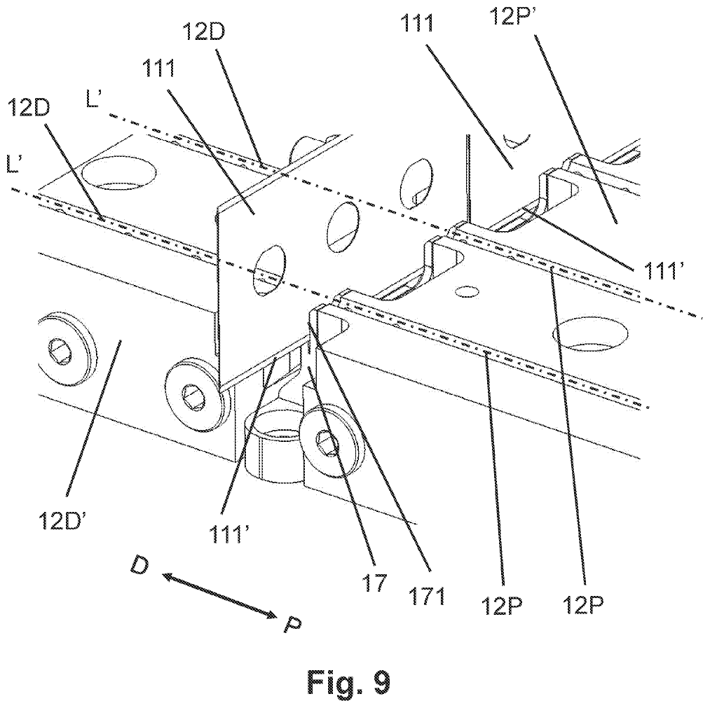

In the following, reference is first made to FIG. 1, FIG. 2, FIG. 3, and FIG. 4, showing different perspective views of a cutting device 1 in accordance with the present disclosure respectively a distal part thereof (FIG. 3, FIG. 4). Further, reference is made to FIG. 7, FIG. 8 and FIG. 9, showing some elements of the cutting device. It is noted that not all reference signs are necessary present in each and every figure showing a referenced element for clarity reasons. Further, features that are present more than once may not be referenced in each figure. The cutting device is exemplarily a cutting device for tubes as elongated workpieces. The tubes may be part of or be used in the assembly or manufacture of a medical product device, for example a balloon catheter.

The direction between proximal and distal is indicated by a corresponding arrow, with proximal being indicated by “P” and distal by “D”. The proximal side of the cutting device 1 is referred to as 1P and the distal side of the cutting device 1 is referred to as 1D. The longitudinal axis of the cutting device 1 (not explicitly shown) extends between the proximal side 1P and the distal side 1D, respectively parallel to the direction between P and D as indicated (best visible in FIG. 1). The direction of gravity is indicated by an arrow labelled “g”. The longitudinal axis L (best visible in FIG. 7, FIG. 8) respectively a direction along which elongated workpieces move from proximal towards distal is arranged horizontally respectively perpendicular to the direction of gravity.

In the shown design, the cutting device 1 is designed for the parallel processing respectively cutting of a maximum of four elongated workpieces and provides accordingly four processing channels. It is noted, however, that it may generally be designed for any desired number of processing channels, including a single processing channel. The arrangement is such that the elongated workpieces are arranged parallel to each other respectively side-by side in a horizontal plane that includes the longitudinal axis L and is transverse to the direction of gravity g. The cutting device 1 includes a device base 1′ (reference in FIG. 2) to which the further components and elements of the cutting device 1 are mounted.

The cutting device 1 includes a common proximal support structure body 12P′ and a common distal support structure body 12D′ that are exemplarily realized in an integral manner and are carried by the device base 1′. For each processing channel, the cutting device 1 includes a proximal guide groove 12P and a distal guide groove 12D. The proximal guide grooves 12P are formed in the upwards-pointing top surface the common proximal support structure body 12P′, and the distal guide grooves 12D are formed in the upwards-pointing top surface the common distal support structure body 12D′. For each processing channel, the cutting device 1 includes a corresponding channel axis L′ (referenced in FIG. 9) in parallel with the longitudinal axis L. For each processing channel the respective longitudinal channel axis L′ is an axis that corresponds to and/or is parallel to an axis of the respective proximal guide grove 12P and distal guide groove 12D.

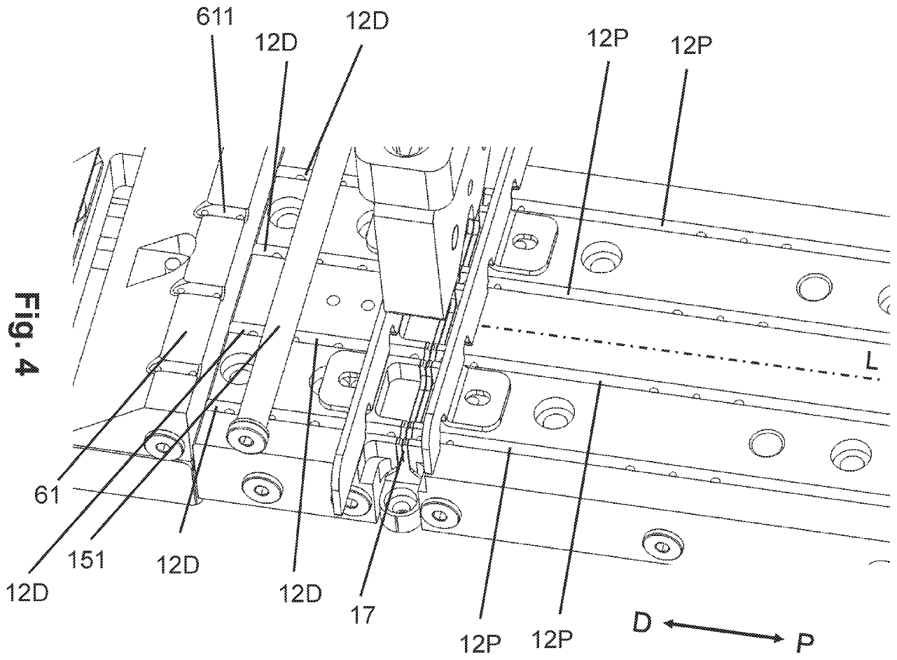

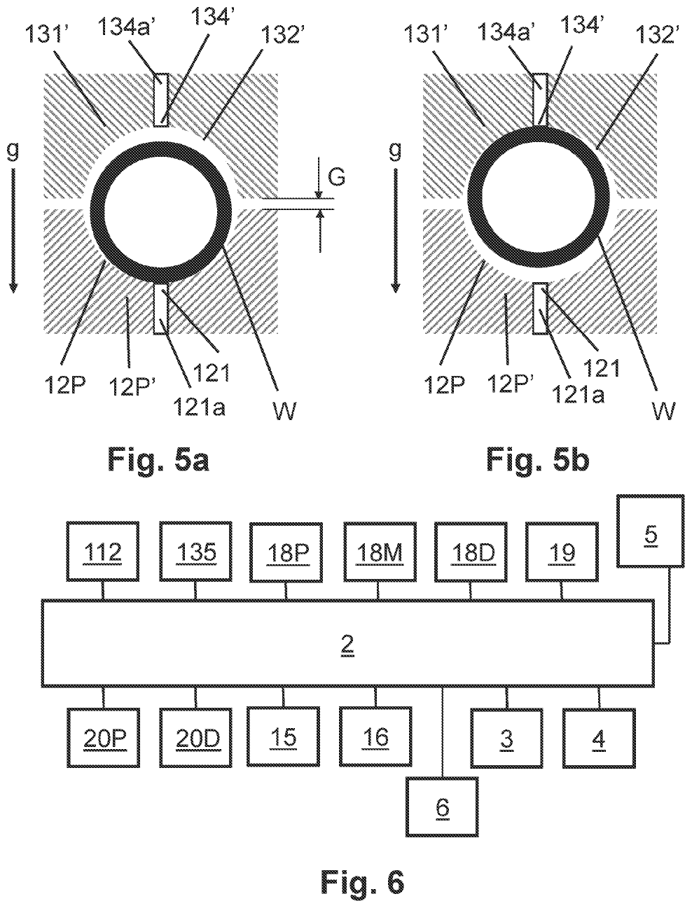

The concave surfaces of the proximal respectively distal guide grooves 12P, 12D form workpiece-contacting surfaces (see also FIG. 5 as discussed further below). For all elongated workpieces respectively processing channels, the respective proximal guide grooves 12P are arranged parallel to each other. Similarly, for all elongated workpieces respectively processing channels, the respective distal guide grooves 12D extend parallel to each other.

Further the respective proximal guide groove 12P and the respective distal guide 12D of each processing channel are aligned with each other, such that the distal guide groove 12D continues respectively extends the proximal guide groove 12P.

The cutting device 1 further includes a cutting unit 11. The cutting unit 11 includes a blade drive 112 and a blade arrangement with exemplarily two blade elements 111, with the blade elements 111 having aligned cutting edges 111′ transverse to the longitudinal axis L and accordingly the channel axes L′ (best visible in FIG. 9). In this design, each of the blade elements 111 is shared by two neighboring processing channels and accordingly cuts-off two neighboring elongated workpieces. It is noted that the section of the cutting edges 111′ that interacts with and cuts an elongated workpiece may be considered as functionally separate blade for the respective elongated blade. It is further noted that also a single blade element or separate blades for each processing channel may be provided. The blade elements 111 are seated in a blade holder 113 (best visible in FIG. 3) which is, in turn coupled to the blade drive 112. The coupling of the blade holder 113 with the blade drive 112 is releasable (in the shown designee via a knurled screw (not referenced)), thereby allowing removal, for example for replacement. The blade drive 112 includes in the shown design a linear motor with an axis that extends transverse to the longitudinal axis L and is skewed with respect to the direction of gravity. Upon actuation, the blade holder 113 with the blade element 111 accordingly moves in a skewed cutting direction and transverse to the elongated workpieces, thereby cutting the elongated workpieces.

A plane in which the blade element 111 extends transverse to the longitudinal axis L defines the cutting plane and separates a proximal part 1P′ of the cutting device 1 and a distal part 1D′ of the cutting device 1 (referenced in FIG. 8).

As best visible in FIG. 7, FIG. 8, and FIG. 9, a blade guide 17 is arranged transverse to the longitudinal axis L and the proximal respectively distal guide grooves, 12P, 12D and accordingly spans all processing channels. Specifically, the blade guide 17 is arranged between and adjacent to the proximal guide grooves 12P and distal guide grooves 12D and separates them with respect to each other. The blade guide 17 comprises a slit 171 that spans the proximal respectively distal guide grooves, 12P, 12D, extends upwards and is open at its upside. A lower portion of the blade elements 111 (facing the elongated workpieces and comprising the cutting edge 111′) is seated in and guided by the slit 171 which is slightly wider than the width of the blade elements 111. The slit 171 extends in the vertical direction below the ground of the proximal and distal guide grooves 12P, 12D (best visible in FIG. 9). The slit 171 generally extends in the cutting plane. Thereby, a continuous passage exists from each proximal guide groove 12P via the blade guide 17 respectively the slit 171 to the respective distal guide groove 12D if the blade elements 111 are in the retracted blade position. Also in the retracted blade position, the blades element 111 favorably dive slightly into the slit 171. In operation, uncut elongated workpieces are seated in the proximal guide grooves 12P, while one or more cut-off pieces are generally seated in the distal guide grooves 12D. It is further noted that in the shown design a single blade guide 17 with a single slit 171 is foreseen. In alternative embodiments with a separate blade for each processing channel of the cutting device, separate blade guides and/or separate slits may be present.

As best visible in FIG. 2, the cutting device 1 includes a number of centering structures that corresponds to the number of proximal guide grooves 12P respectively the number of processing channels of the cutting device 1. In the shown design, the centering structures each include a first centering structure and a second centering structure. The first centering structures each include a first centering groove 14P and the second centering structures each include a second centering groove 14D. The first centering groove 14P and the second centering groove 14D are in each case aligned with each other and the respective proximal guide groove 12P with the respective channel axis L′.

For each processing channel of the cutting device 1, a distal end of the first centering groove 14P is adjacent to the proximal end of the respective second centering groove 14D. Further, the distal end of the second centering groove 14D is adjacent to the proximal end of the respective first proximal guide groove 12P. With other words, the first centering groove 14P, the second centering groove 14D and the proximal guide groove 12P are arranged one after the other in longitudinal direction respectively along the channel axis L′ of the respective processing channel. In any case, the first centering groove 14P continuously merges into the second centering groove 14D, and the second centering groove 14D continuously merges into the proximal guide groove 12P of the respective processing channel.

In the shown embodiment, all first centering structures are integrally formed by a common first centering structure body 14P′ (best visible in FIG. 2) that is exemplarily realized by a sheet metal part that is bent to provide the V-shaped or U-shaped first centering grooves 14P. Similarly, the second centering structures are formed in an integral manner with the second centering grooves 14D being formed by machining in a common second centering structure body 14D′ (best visible in FIG. 2). The first centering structure body 14P′ and the second centering structure body 14D′ may be mounted respectively attached to the device base. The first centering grooves 14P and the distal centering grooves 14D are typically U-shaped or V-shaped.

As best visible in FIG. 7, apertures 121 are provided that open into the proximal guide grooves 12P and distal guide grooves 12D respectively their workpiece contacting surfaces for suction-coupling of the elongated workpieces. For the proximal guide grooves 12P, such apertures 121 are generally provided at three longitudinal positions, that are spaced apart along the longitudinal axis L, namely a proximal coupling position 121P, a middle coupling position 121M and a distal coupling position 121D. By way of example, two apertures are provided next to each other in close longitudinal proximity at the proximal coupling position 121P and the distal coupling position 121D, while three apertures are provided next to each other in close longitudinal proximity at the middle coupling position 121M. For each of the proximal coupling position 121P, the middle coupling position 121M and the distal coupling position 121D, the individual apertures 121 respectively the flow conduits that open into the apertures 121 are fluidically coupled. The apertures 121 at the proximal coupling position 121P, the middle coupling position 121M and the distal coupling position 121D are in each case coupled with separate control valves via a corresponding fluidic conduit. As also visible in FIG. 4, further fluidic conduits (not separately referenced) are provided that open into the distal guide groove respectively its workpiece contacting surface for suction coupling with the cut-off pieces. A number of apertures 121 is further provided in a longitudinal spaced apart manner for each the distal guide grooves 12D. Favorably, the apertures 121 at the distal coupling position 121D as well as an aperture 121 of the distal guide groove 12D are provided directly proximately respectively distally from the blade guide 17 in close longitudinal proximity thereto.

As best visible in FIG. 2, a lifting unit platform 61 is arranged distally from the distal guide grooves 12D respectively the distal support structure body 12D′. The lifting unit platform 61 belongs to a lifting unit 6 (see FIG. 6) and further includes a lifting drive as described above in the general description. For each processing channel, the lifting unit platform 61 includes a respective lifting unit guide groove 611. In the aligned position of the lifting platform 61, each lifting unit guide groove 611 extends the respective distal guide groove 12D in the distal direction D.

The feeder unit 13 includes a suction gripper drive which in the shown design is realized as motorized linear axis 135 that extends parallel to the longitudinal axis L respectively in the proximal-distal direction. Further, the feeder unit 13 includes for each processing channel a suction gripper 131 (referenced in FIG. 3) with a proximal suction gripper element 131P and a distal suction gripper element 131D. Exemplarily, all proximal suction gripper elements 131P are integrally formed with each other as proximal suction gripper member 131P′ and all distal suction gripper elements 131D are integrally formed with each other as distal suction gripper member 131D′, which however is not essential. The proximal suction gripper member 131P′ and the distal suction gripper member 131D′ are connected by a suction gripper bridge 133. In this design, the proximal suction gripper member 131P′ and the distal suction gripper member 131D′ respectively all proximal suction gripper elements 131P and distal suction gripper elements 131D are displaceable together via the linear axis 135.

Each of the proximal suction gripper elements 131P and distal suction gripper elements 131D is favorably shaped to allow dipping into second centering groove 14D of the respective second centering structure, thereby allowing suction-coupling with an elongated workpiece seated therein.

A deionization nozzle 151 (best visible in FIG. 3) spans all distal guide grooves 12D and a respectively particle removal nozzle 161 (best visible in FIG. 1, FIG. 2) is arranged distally from the distal support structure body 12D′.

In the following, reference is additionally made to FIG. 5a and FIG. 5b, illustrating the alternative suction coupling of an elongated workpiece W, in particular a tube, with a suction gripper element 131′ and the proximal support structure respectively proximal guide groove 12P. Depicted is the schematically sectional view transverse to the longitudinal axis L respectively the channel axis L′ of the proximal guide groove 12P of either of the processing channels. The suction gripper element 131′ may in particular be either the proximal suction gripper element 131P or the distal suction gripper element 131D of a suction gripper 131. The same applies to the workpiece coupling structure 132′, which may either be the workpiece coupling structure 132D of the distal suction gripper element 131D or the workpiece coupling structure 132P of the proximal suction gripper element 131P (see FIG. 3). It can be seen that a gap G is present between a lower side of the suction gripper element 131′ and the upper side of the proximal support structure 12P. In the situation as shown in FIG. 5a, suction coupling of the elongated workpiece W with the proximal support structure 1 respectively the proximal guide groove 12P is activated by a negative pressure being applied at the aperture 121 via a corresponding fluidic conduit 121a, while the suction coupling of the elongated workpiece W with the suction gripper element 131′ is deactivated. Consequently, the elongated workpiece W is seated in the proximal guide groove 12P and is in contact in the area of its ground, while a gap is present to the workpiece coupling structure 132′ of the suction gripper element 131′. In the situation as shown in FIG. 5b, suction coupling of the elongated workpiece W with the suction gripper element 131′ is activated by a negative pressure being applied at the aperture 134′ via corresponding fluidic conduit 134a′, while suction coupling with the elongated workpiece W with the proximal support structure respectively proximal guide groove 12P is deactivated. Consequently, the elongated workpiece W is lifted to the suction gripper element 131′ and touches the workpiece coupling structure 132′ in the area of its apex, while a gap is present between the elongated workpiece W and the ground of the proximal guide groove 12P.

In the following, reference is additionally made to FIG. 6, showing an assembly line in accordance with the present disclosure in a schematic functional view. The assembly line includes a control unit 2 which is in this embodiment a control unit of the cutting device 1 as explained before as well as a control unit of the assembly line in general. Exemplarily, further assembly stations 3, 4 of the assembly line are shown. The assembly line may be an assembly line for a medical product device, for example a balloon catheter. The assembly line, including the cutting device, may be designed for use in a clean-room environment.

The control unit 2 may optionally further be operatively coupled with a higher-level or overall control system 5 that may, for example control operation of and/or coordinate a number of assembly lines and/or further systems such as transporting systems and handling robots.

The control unit 2 is typically based on one or more programmable devices, such as programmable logic controllers (PLCs), And/or industrial PCs, running a corresponding software code. It is noted that the control unit can be realized by any combination of hardware and software components as required and feasible in a specific context. The control unit 2 may further include readily available control devices, such as actuator/motor controllers and valve controllers.

The control unit 2 is configured to control operation of the cutting device 1 in a manner as mentioned before. Regarding the cutting device 1, control unit 2 controls operation of the blade drive 112, the suction gripper drive respectively linear axis 135. Further, control unit 2 controls operation of control valve 20P for controlling suction-coupling of elongated workpieces with a respective proximal suction gripper part 131P and of control valve 20D for controlling suction-coupling of elongated workpieces with a respective distal suction gripper part 131D. Further, control unit 2 controls operation of control valve 18P, 18M, 18D for controlling suction coupling of elongated workpieces with a respective proximal support structure 12P at the proximal coupling position 121P, middle coupling position 121M, and distal coupling position 121D, respectively. The control unit 2 further controls operation of control valve 19 for controlling suction coupling of the distal support structure 12D with cut-off pieces. Further, control unit 2 controls operation of ionization unit 15 and particle removal unit 16. The control unit 2 further controls operation of the lifting unit 6 respectively its lifting drive to move the lifting platform 61 between its aligned position and offset position.

In an operational configuration, all of the control valves 112 are fluidically coupled with a vacuum pump respectively negative pressure supply as well as the respective fluidic conduits as mentioned before via corresponding tubing. It is noted that all control valves 18P, 18M, 18D, 19, 20P, 20D are shown only once. In dependence of the overall fluidic design however, some or all of the control valves may be replicated in accordance with the number of processing channels.

It is noted that each of the shown control valves may also be implemented by a number of distinct control valves that are operated in parallel, in dependence with the valve designs and required flow rates.

In operation of the cutting device 1, the ionization unit 15, the dust removal 16 as well as the suction at the distal coupling structures 12D′ respectively the distal guide grooves 12D may be continuously activated.

### REFERENCE SIGNS

1 cutting device
1′ device base
1P proximal side
1D distal side
1P′ proximal part
1D′ distal part
11 cutting unit
111 blade/blade element
111′ cutting edge
112 blade drive
113 blade holder
12P proximal guide groove (part of proximal support structure)
12P′ proximal support structure bod ((part of proximal support structure)
12D distal guide groove (part of distal support structure)
12D′ distal support structure body (part of distal support structure
121 aperture
121a fluidic conduit (to aperture 121)
121P proximal coupling position
121M middle coupling position
121D distal coupling position
13 feeder unit
131 suction gripper
131′ suction gripper element
131P proximal suction gripper element
131P′ proximal suction gripper member
131D distal suction gripper element
131D′ distal suction gripper member
132P workpiece coupling structure (to proximal suction gripper element
131P)
132D workpiece coupling structure (to distal suction gripper element
131D)
132′ workpiece coupling structure (to suction gripper element 131′)
133 suction gripper bridge
134′ aperture (to suction gripper element 131′)
134a′ fluidic conduit (to aperture 134′)
135 suction gripper drive/linear axis
14P first centering groove (part of first centering structure)
14P′ first centering structure body (part of first centering structure)
14D second centering groove (part of second centering structure)
14D′ second centering structure body (part of second centering structure)
15 ionization unit
151 ionization nozzle
16 particle removal unit
161 particle removal nozzle
17 blade guide
171 slit
18P control valve (proximal coupling position)
18M control valve (middle coupling position)
18D control valve (distal coupling position
19 control valve (distal support structure)
20P control valve (for proximal suction gripper element 131P)
20D control valve (for distal suction gripper element 131D)
2 control unit
3, 4 assembly station
5 overall control system
6 lifting unit
61 lifting unit platform
611 lifting unit guide groove
g direction of gravity
D distal direction
G gap
P proximal direction
W elongated workpiece
L longitudinal axis
L′ channel axis

1. A cutting device for cutting-off pieces from an elongated workpiece, the cutting device having a proximal side, a distal side and a longitudinal axis extending between the proximal side and the distal side, the cutting device including:
a cutting unit, the cutting unit including a blade and a blade drive, wherein the blade is coupled with the blade drive, wherein the blade is reversibly movable via the blade drive between a retracted blade position and an advanced blade position;
a proximal support structure, wherein the proximal support structure is arranged proximal of the blade along the longitudinal axis and is configured to guide a distal part of the elongated workpiece to be movable in parallel to and aligned with the longitudinal axis;
a feeder unit, the feeder unit including:
a suction gripper, wherein the suction gripper is configured for suction-coupling with the elongated workpiece;
a suction gripper drive, wherein the suction gripper drive is coupled with the suction gripper, wherein the suction gripper drive is configured for moving the suction gripper parallel to the longitudinal axis in a reversible manner.

2. The cutting device according to claim 1, wherein the blade and the suction gripper are arranged in a vertical direction above the proximal support structure.

3. The cutting device according to claim 1, wherein the suction gripper includes a proximal suction gripper element and a distal suction gripper element, wherein the proximal suction gripper element and the distal suction gripper element are arranged spaced apart along the longitudinal axis, wherein the proximal suction gripper element and the distal suction gripper element are each configured for suction-coupling with the elongated workpiece.

4. The cutting device according to claim 3, wherein the suction-coupling of the proximal suction gripper element and the distal suction gripper element with the elongated workpiece is independently activatable and deactivatable.

5. The cutting device according to claim 1, wherein the proximal support structure includes a proximal guide groove.

6. The cutting device according to claim 5, wherein the cutting device includes a centering structure in alignment with the proximal guide groove.

7. The cutting device according to claim 1, wherein the proximal support structure is configured for suction-coupling with the elongated workpiece.

8. The cutting device according to claim 7, wherein the proximal support structure is configured for suction-coupling with the elongated workpiece at a proximal coupling position, a middle coupling position and a distal coupling position, wherein the proximal coupling position, the middle coupling position and the distal coupling position are spaced apart along the longitudinal axis, wherein suction-coupling of the proximal support structure with the elongated workpiece at the proximal coupling position, the middle coupling position and the distal coupling position is in each case independently activatable and deactivatable.

9. The cutting device according to claim 1, wherein the cutting device includes a distal support structure, wherein the distal support structure is arranged distal of the blade and is configured to receive pieces being cut-off from the elongated workpiece.

10. The cutting device according to claim 9, wherein the distal support structure is configured for suction-coupling with cut-off pieces subsequent to being cut off from the elongated workpiece.

11. The cutting device according to claim 1, wherein the cutting device further includes and/or is configured for operative coupling with a control unit, wherein the control unit is configured for controlling operation of the cutting device, including operation of the blade drive, the suction gripper drive and the suction-coupling of each of the suction gripper with the elongated workpiece.

12. An assembly line for the assembly of a product device, the assembly line including at least one cutting device according to claim 1.

13. A method for cutting-off pieces from an elongated workpiece, the method including repeatedly executing a cutting sequence, by the cutting device according to claim 1, the cutting sequence including steps of:
a) suction-coupling the distal part of the elongated workpiece with the suction gripper, wherein the suction gripper is in a pickup position;
b) moving the suction gripper with the coupled elongated workpiece from the pickup position parallel to the longitudinal axis in a distal direction into a placing position, wherein, in the placing position, the elongated workpiece projects in the distal direction beyond the blade;
c) releasing the suction-coupling of the suction gripper and the elongated workpiece;
d) moving the blade form the retracted blade position into the advanced blade position, thereby cutting-off a piece from the elongated workpiece, and back into the retracted blade position;
e) moving the suction gripper from the placing position into the pickup position.

14. The method according to claim 13, the method further including guiding the distal part of the elongated workpiece by the proximal support structure to be movable in a guided manner parallel to and aligned with the longitudinal axis.

15. The method according to claim 14, wherein the step (c) includes suction-coupling the proximal support structure with the elongated workpiece, and step (a) includes releasing the suction-coupling of the proximal support structure with the elongated workpiece.

16. The method according to claim 15, wherein the proximal support structure is arranged proximal of the blade, wherein the proximal support structure is configured for coupling with the elongated workpiece at a proximal coupling position, a middle coupling position and a distal coupling position, wherein the proximal coupling position, the middle coupling position and the distal coupling position are spaced apart along the longitudinal axis;
wherein the suction gripper includes a proximal suction gripper element and a distal suction gripper element, wherein the proximal suction gripper element and the distal suction gripper element are arranged spaced apart along the along the longitudinal axis, wherein the proximal suction gripper element and the distal suction gripper element are each configured for a coupling with the elongated workpiece by way of suction, wherein the step (c) includes:
c1) suction-coupling the proximal support structure with the elongated workpiece at the distal coupling position;
c2) suction-coupling the proximal support structure with the elongated workpiece at the middle coupling position and releasing the suction-coupling of the distal suction gripper element with the elongated workpiece;
c3) suction-coupling the proximal support structure with the elongated workpiece at the proximal coupling position and releasing the suction-coupling of the proximal suction gripper element with the elongated workpiece.

17. The method according to claim 13, the method further including, executing an initialization sequence prior to repeatedly executing the cutting sequence, the initialization sequence including:
i-a) suction-coupling the elongated workpiece with the suction gripper;
i-b) moving the suction gripper with the coupled elongated workpiece parallel to the longitudinal axis in the distal direction while the blade is in the advanced blade position, such that the blade abuts the elongated workpiece and pushes the elongated workpiece into a proximal direction;
i-c) releasing the suction coupling of the suction gripper and the elongated workpiece;
i-d) moving the blade from the advanced blade position into the retracted blade position.

18. (canceled)

19. The method according to claim 13, wherein the elongated workpiece is a tube.

20. The cutting device according to claim 1, wherein the elongated workpiece is a tube.
